(19) United States
(12) Patent Application Publication
(10) Pub. No.: US 2025/0267156 A1
(43) Pub. Date: Aug. 21, 2025

(54) CYBER SECURITY SYSTEM FOR EMAIL MESSAGE PROTECTION

(71) Applicant: Darktrace Holdings Limited, Cambridge (GB)

(72) Inventors: Stephen Pickman, Huntingdon (GB); Ben Akrill, Cambridge (GB); Will Hodkinson, High Peak (GB); Steven Haworth, Cambridge (GB); James Wingar, Cambridge (GB)

(21) Appl. No.: 19/058,593

(22) Filed: Feb. 20, 2025

Related U.S. Application Data
(60) Provisional application No. 63/555,823, filed on Feb. 20, 2024.

(51) Int. Cl. H04L 9/40

(52) U.S. Cl. CPC H04L 63/1416; H04L 63/04

(57) ABSTRACT

Implemented within a cyber security appliance, a non-transitory storage medium configured to store software that, when executed, conducts data loss prevention evaluation of an email message to protect against exfiltration of sensitive data from an enterprise. The software includes an email protection module and high availability (HA) fail-open control logic. The email protection module includes email threat detection logic to analyze content associated with an outbound or lateral email message for potential data loss characteristics. The HA fail-open control logic is configured to (i) detect operational failure of the email protection module or intake disruption of email messages via an Application Programming Interface (API) providing access to the email protection module and (ii) redirect the email messages to HA cloud infrastructure pertaining to the enterprise for temporary storage and subsequent release of the redirected email messages upon detecting the operational failure or the intake disruption.

### RELATED APPLICATIONS

This application claims priority under 35 USC § 119 to U.S. Provisional Patent Application No. 63/555,823, entitled “Cyber Security” filed on Feb. 20, 2024, where content of this application is incorporated by reference herein.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments of the design provided herein generally relate to electronic mail (email) message security, and in particular, data loss protection and AI-based security mailbox assistance.

### BACKGROUND

Data loss protection (DLP) through a rule-based system involves creating predefined policies and rules to identify and safeguard sensitive information inclusive of confidential information or personally identifiable information (PII) for example. These rules dictate how data should be handled, shared, and protected, aiming to prevent unauthorized access or accidental leaks. Rule-based DLP systems monitor data in various states—at rest, in motion, and in use—by comparing data activities against the established rules. However, this approach has several limitations.

First, the rule-based DLP systems are not configured to conduct analytics of the content outbound electronic mail (email) messages to adequately address DLP concerns. Also, the static nature of rule-based systems often struggles to keep up with the dynamic and evolving nature of data usage and cyber threats, leading to higher rates of false positives and false negatives. Additionally, rule-based DLP systems typically lack context awareness, making it difficult to differentiate between legitimate business activities and potential data loss that may occur through insider threats that are difficult to detect and perpetuated through lateral email messages, which can be either malicious (data breaches) or accidental. Scalability is another challenge, as managing and updating numerous rules can become resource-intensive and prone to errors, especially in large and complex data environments. Lastly, user experience in data loss prevention has been lackluster and an improved experience to drive more end user involvement in data loss prevention is needed for better DLP system efficacy.

These limitations highlight the need for more adaptive and context-aware approaches to data loss prevention.

### SUMMARY

A cyber security appliance and its models and modules have been developed to enhance data loss protection of outbound email messages from an enterprise based on behavioral characteristics of that enterprise (e.g., a corporation, organization, governmental entity, partnership, group of persons, etc.) and/or personnel within that enterprise (generally referred to as “end user”). Herein, the cyber security appliance may be a physical device or a logical device (e.g., software instance) configured with software components to protect the enterprise from data loss, namely the loss of sensitive information such as confidential or personally identifiable information (PII) for example. Examples of these software components may include, but are not limited or restricted to an email protection module, a network module, one or more artificial intelligence (AI) models, a cyber threat analyst module, an autonomous response module, user interface (UI) generation module, and a communication module with input/output (I/O) ports.

In general terms, conventional email security modules, such as Antigena™ Email provided by Darktrace of Cambridge, United Kingdom, can prevent data loss. Data loss prevention (DLP) is an ongoing challenge facing difficulties in managing prevention of inadvertent or malicious sensitive data loss via email.

Currently, conventional email security modules can reduce reliance on email gateways that have the power to stop outgoing email messages, but only if that email message meets a set of predefined rules. Over the last few years, security person(s) for an enterprise, generally referred to as a security operations center “SOC” team herein, have found that maintaining email gateway's DLP rules require too much management, and as a result, are either too permissive thereby increasing the risk of data loss events or too restrictive thereby interrupting legitimate business activity and adding to SOC team workloads. In particular, each year, a SOC team needs to invest vast amounts of time to write and maintain email gateway DLP rules and configurations.

In contrast, an improved email security solution, represented as the email protection module described below, is configured to conduct pattern of life analyses unique to each mailbox and/or each enterprise, identify potential data loss evidenced by data loss, leakage, or misuse of sensitive data, and prevent the release of outbound or lateral email messages pertaining to data loss characteristic (i.e. a data loss condition). The email protection module is adapted to conduct DLP analytics (e.g., different weightings, review specific parameters directed to particular types of data loss in accordance with ‘pattern of life’ analyses, etc.) on different types of email messages, determined by classifiers and one or more large language models (LLMs), to identify those email messages with potential data loss characteristics. Additionally, the email protection module may be configured to integrate with third-party tools, such as Azure™ resources for example, to ensure information protection sensitivity labels are assigned to assist the email protection module in performing its DLP analytics. The email protection module can prevent data loss with a level of in-depth analysis and easy adoption, combined with easy set up.

This email protection module can respond to lateral threats. In particular, the email protection module can provide in-depth analysis of email messages between internal mailboxes to identify and respond to lateral threats. This operability will allow a SOC team full visibility of all email messages in an email console and will assist threat hunting exercises. Suspicious lateral email messages will automatically be submitted for deep investigation by the email protection module to identify potential account compromise or malicious intent; where this is found, action can be taken.

Furthermore, the email protection module is further configured to provide a security mailbox assistant logic that offers end users new ways to engage with the SOC team and report suspicious email messages. The security mailbox assistant logic is adapted to provide feedback to an end user reporting an email security threat (e.g., an attempted data exfiltration) within a few seconds, which encourages users to adopt good security practices. The email protection module can automate SOC team actions such as removing reported email messages present in mailboxes of other users until the SOC team has been able to investigate the reported email message. The email protection module can further automate investigations and workflows. For example, when end users report an email message as potentially suspicious, the email protection module may be configured to automatically launch an in-depth investigation, automating SOC team's triage workflow, and generate feedback messages to the end users to engage them as part of the DLP process.

According to one embodiment of the disclosure, the email protection module is configured to operate in combination with a data labeling classification engine accessible through the data labeling API with High Availability (HA) fail-open control logic configured to detection disruption of an email flow loop arranged to monitor outbound email messages and/or lateral email messages within an enterprise. The email protection module includes (i) email classification logic; (ii) HA fail-open control logic; (iii) email threat detector logic including email DLP logic (inbound, outbound, lateral analysis modules), where the email DLP logic is adapted for communication with the email classification logic and Artificial Intelligence based (AI-based) logic such as one or more large language models (LLMs) and/or AI models. The email protection module further includes user interface (UI) connection logic and security mailbox assistant logic for feedback generation via the UI connection logic.

More specifically, the HA fail-open control logic is configured to eliminate the email protection module from being a single point of failure so that operational failure of the email protection module or an Application Programming Interface (API), providing the email protection module with access to output from the data labeling classification engine, do not preclude outbound or lateral email messages due to failure of this module. Instead, the HA fail-open control logic prevents the halting of outbound email messages by the enterprise in response to failure of the email flow loop. Such prevention may be initiated by signaling the data labeling classification engine to temporarily route at least analyzed outbound email messages to HA infrastructure located in one or more enterprise-based cloud environments operating in cloud networks that may span different geographic regions. The HA infrastructure is adapted to operate as an email message queue that permits transmission of the outbound email messages after imposing a brief ‘hold’ (e.g., less than a few seconds) of each outbound email message. The HA infrastructure is relied upon in response to a failure of the email flow loop associated with outbound email message handled by the email DLP logic.

Herein, the email threat detector logic includes email DLP logic, which is configured to conduct real-time analytics on content associated with an outbound or lateral email message under evaluation (hereinafter, “evaluated email message”) for potential data loss characteristics, such as accidental or intentional exfiltration of sensitive data for example. These real-time analytics may be conducted on metadata associated with the evaluated email messages, features associated with that email message, or AI-based results involving activities associated with the enterprise, user or device sourcing or receiving the evaluated email message.

As an illustrative example, the features obtained from content uncovered from parsing the targeted email message may be directed to features pertaining to content within a header of the targeted email message, features pertaining to content within a body portion of the targeted email message, and/or features pertaining to content within any attachment.

Additionally, the features corresponding to correlation results may be based on a comparison of features associated with the evaluated email message representing behavioral characteristics associated with an enterprise, end user, and/or computing device against normal patterns of email activity by the enterprise, end user and/or computing device. The normal patterns of email activity may be provided by AI models deployed within the cyber security appliance, and results of this comparison (correlation results) may be provided to the email DLP logic.

Thereafter, based on receipt of features from different input sources, the email DLP logic is configured to conduct real-time DLP operations by analyzing these features and perhaps operating with the cyber threat analysis module within the cyber security appliance to generate a DLP confidence score to identify whether data loss characteristics exist and DLP prevention is warranted. Herein, the email DLP logic may be configured to apply a different set of weightings based on the type of evaluated email message (outbound, lateral) and/or the type of potential data loss characteristic (e.g., accidental data loss or malicious data loss). Any outbound or lateral email messages that failed the DLP analytics (DLP confidence score less than a prescribed threshold value) would be halted from transmission by the cyber security appliance.

As stated above, the DLP operations may be different depending on the type of data loss: accidental data loss or malicious data loss. For example, accidental data loss is generally more difficult to detect because the data loss may be directed to a situation where an outbound email message is being sent to the wrong end user. The DLP operations associated with accidental data loss is directed to destination information and context associated with such communications. DLP operations associated with malicious data loss may be directed to size of the email messages, content of attachments, type of data being exfiltrated rather than the targeted destination for the email message.

Additionally, the cyber security appliance is configured with UI connection logic and/or security mailbox assistant logic adapted to provide a mechanism that enhances feedback responses to an end user reporting an email security threat (e.g., a potential accidental or malicious data exfiltration). Such enhancements may be based on prompt feedback message(s) to the end user identifying receipt of the submitted email message along with (or followed by) additional messages to identify whether the message constituted a data loss security threat and/or a brief explanation of the notable factors as to why this message warranted DLP intervention (generated by LLM). The feedback message(s) are configured to encourage end users to adopt good security practices.

These and other features of the design provided herein can be better understood with reference to the drawings, description, and claims, all of which form the disclosure of this patent application.

### DRAWINGS

The drawings refer to some embodiments of the design provided herein in which:

FIG. 1 illustrates a block diagram of an embodiment of a cyber security appliance that comprises an email protection module configured to evaluate the features of an email message have data loss characteristics.

FIG. 2 illustrates a block diagram of the email protection module deployed within the cyber security appliance of FIG. 1.

FIG. 3 is a flow diagram of illustrative operations conducted in accordance with an email flow loop inclusive of the email protection module and a data labeling classification engine deployed within the cyber security appliance of FIG. 1.

FIG. 4 illustrates a block diagram of an embodiment of a cyber security platform with a cyber security appliance adapted to monitor email activity with assistance from LLM(s) and a data labeling classification engine.

FIG. 5 illustrates an exemplary block diagram of autonomous actions automatically conducted by the autonomous response module of FIG. 1.

FIG. 6 illustrates an exemplary cyber security appliance protecting an example network.

FIG. 7 illustrates a block diagram of an embodiment of one or more computing devices that can be a part of an embodiment of the AI-based cyber security appliance discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details associated with aspects of embodiments of the disclosure are set forth in order to provide a thorough understanding of the present design. It will be apparent, however, to one of ordinary skill in the art that the present design can be practiced without these specific details. In other instances, well known components or methods have not been described in detail, but may be represented as part of a block diagram in order to avoid unnecessarily obscuring the present design. Further, specific numeric references, such as use of the terms “first” and “second” for example, should not be interpreted as a literal sequential order. Rather, these numeric references may be used to denote different features (e.g., components, operations, functionality, etc.) that are merely exemplary. Also, the features implemented in one embodiment are not restricted to that embodiment, but rather, may be implemented in another embodiment where logically possible. The specific details can be varied from and still be contemplated to be within the spirit and scope of the present design.

### I. Terminology

In the following description, certain terminology is used to describe various features of the invention. For example, the terms “module,” “logic” and “component” are structures that can be implemented with electronic circuits, software stored in a memory executed by one or more processors, and/or a combination of both. For instance, the module (or logic or component) may be representative of hardware, firmware or software that is configured to perform one or more functions. As hardware, a module (or logic or component) may include physical circuitry having data processing or storage functionality. Examples of such circuitry may include, but are not limited or restricted to a hardware processor (e.g., microprocessor with one or more processor cores, a digital signal processor, a graphics processing unit (GPU), a programmable gate array, a microcontroller, an application specific integrated circuit “ASIC,” etc.), a semiconductor memory, or digital or analog hardware.

Alternatively, the module (or logic or component) may be software that includes code being one or more instructions, commands, files, or another data structures that, when compiled and/or processed (e.g., executed), perform a particular operation or a series of operations. Examples of software may include an application, a process, an instance, an Application Programming Interface (API), a routine, a subroutine, a plug-in, a function, an applet, a servlet, code, a script, a shared library/dynamic link library (dll), logical circuitry (e.g., logical functionality of the physical circuitry descried above), or one or more instructions. This software may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; non-persistent storage such as volatile memory (e.g., any type of random-access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the module (or logic or component) may be stored in persistent storage.

In general, the term “infrastructure” generally relates to any logical or physical component that performs a specific task or function, such as managing security of a logical or physical network, data storage, virtual processing, or the like. Hence, cloud infrastructure relates to one or more logical components that perform a specific task or function within a cloud network. Examples of infrastructure may include, but are not limited or restricted to ephemeral, cloud-based components or services such as compute engines (e.g., AWS™ EC2, Azure® Azure® virtual machines, Google® compute engine, etc.), logical data stores (e.g., AWS™ S3, Azure® blob storage, etc.), policies, roles, users, certificates, virtual machines, network-based assets such as virtual private clouds (VPCs) or subnets, edges (communication paths between two logical components), or the like (also referred to as “ephemeral cloud assets”).

The term “content” generally relates to a collection of information, whether in transit (e.g., over a network) or at rest (e.g., stored), often having a logical structure or organization that enables it to be classified for security threat detection and prevention.

The term “computing device” should be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing may include, but are not limited or restricted to, the following: a server, a mainframe, a firewall, a router; or an endpoint device (e.g., a laptop, a smartphone, a tablet, a desktop computer, a netbook, gaming console, a wearable, etc.), or the like. The term “computing device(s)” denotes one or more computing devices.

The term “interconnect” may be construed as a physical or logical communication path between two or more components or between different components. For instance, a physical communication path may include wired or wireless transmission mediums. Examples of wired transmission mediums and wireless transmission mediums may include electrical wiring, optical fiber, cable, bus trace, a radio unit that supports radio frequency (RF) signaling, or any other wired/wireless signal transfer mechanism. A logical communication path may include any mechanism that allows for the exchange of content between different components such as function calls or other message delivery techniques.

The term “message” generally refers to signaling (wired or wireless) as either information placed in a prescribed format and transmitted in accordance with a suitable delivery techniques such as a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frames, or any other series of bits having the prescribed, structured format. The term “computerized” generally represents that any corresponding operations are conducted by hardware in combination with software or firmware.

The character set “(s)” denotes one or more items. For example, the term “network(s)” denotes one or more networks. The term “components(s)” denotes one or more components. The term “cloud modules(s)” denotes one or more cloud modules, and the like.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of components, logic, functions, steps, or acts are in some way inherently mutually exclusive.

### II. General Architecture

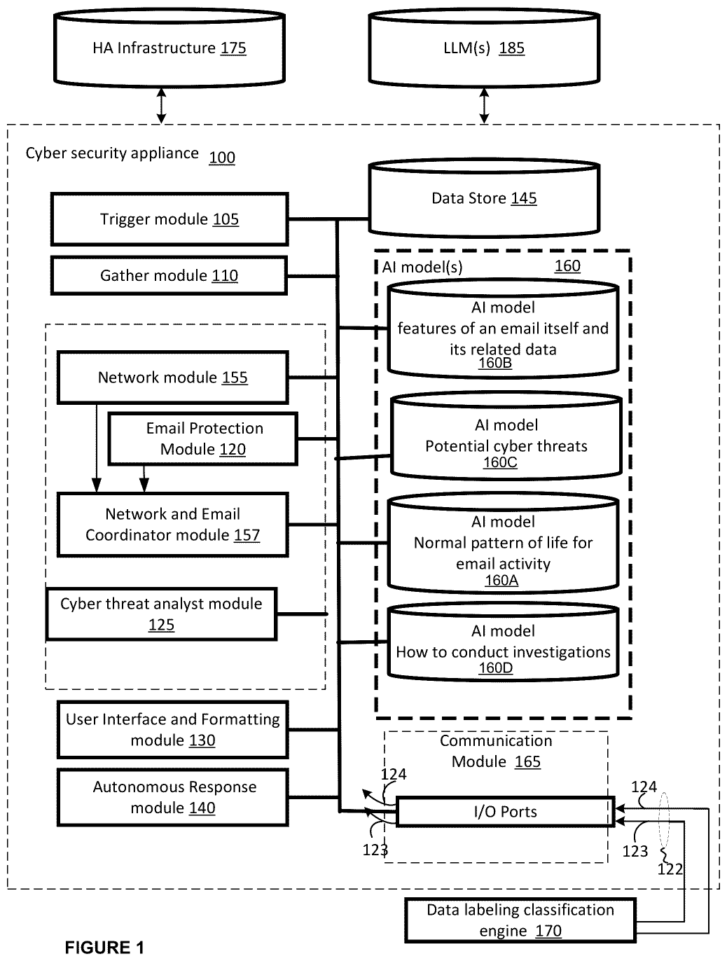

Referring to FIG. 1, an illustrative block diagram of an embodiment of a cyber security appliance 100 with an email protection module 120 and a cyber threat analyst module 125 is shown. For this embodiment, the email protection module 120 may be configured to conduct analytics on incoming email messages, notably one or more email messages 122 received for evaluation from a data labeling classification engine (not shown) via a communication module 165 featuring input/output (I/O) ports (hereinafter, “evaluated email message” or in some cases “email message”). The evaluated email messages include outbound email messages 123 and/or lateral email messages 124.

According to one embodiment of the disclosure, the outbound email message 123 constitutes an email message directed from an end user operating within an enterprise to a recipient external from the enterprise. The lateral email message 124 constitutes an email message directed from an end user operating within the enterprise to a recipient within the same enterprise. Each of these evaluated email messages 122 includes a header section and a body section, where the header section includes (i) a source (From) email address field, (ii) a recipient (To) email address field, (iii) an email subject line, and/or (iv) time stamp (e.g., when email received) and the body section includes alphanumeric characters and/or symbols to convey context surround the reason for the email message. The email message(s) 122 may further include one or more attachments.

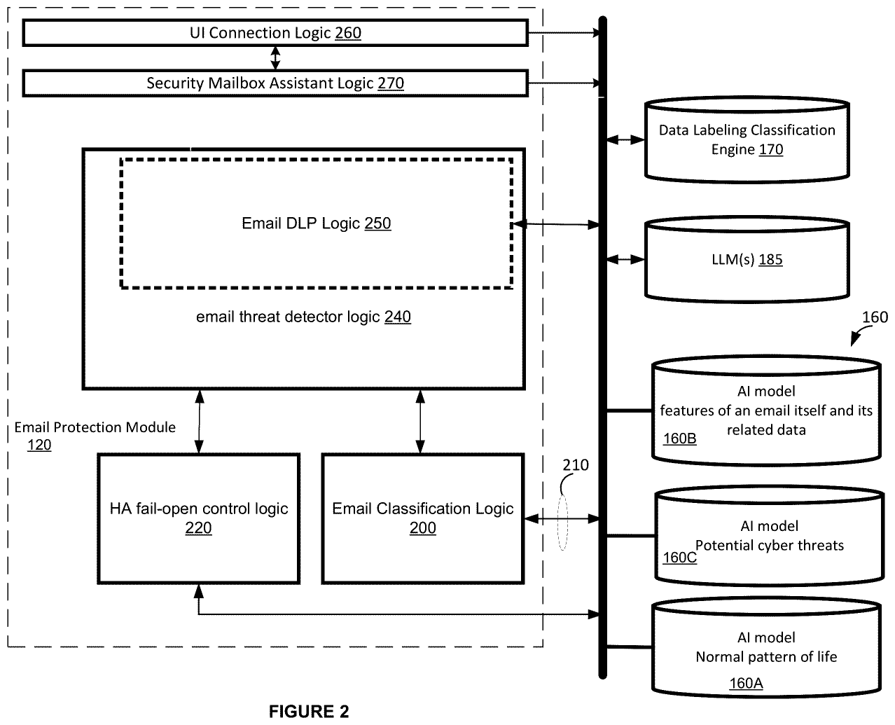

In general, the email protection module 120 is configured with email threat detection logic (see FIG. 2) adapted for data loss prevention (DLP). The email protection module 120 is communicatively coupled to a data labeling classification engine 170 (e.g., Microsoft® Purview) and utilizes behavioral learning to detect anomalous data exfiltration in outbound email messages, relying on a highly available (HA), fail-open architecture 175 to avoid single point failure. The email protection module 120 further conducts DLP analytics of lateral email messages, where the email protection module 120 may apply different weighting to analyze lateral email messages within an enterprise compared to outbound email messages that are directed to an external recipient. The email protection module 120 further includes security mailbox assistant logic (see FIG. 2), which assists in training of good security practices by enterprise end users in report suspicious email messages as described below.

Additionally, the email protection module 120 may be configured to reference some or all of the machine learning model (generally referred to as “AI model(s) 160). According to one embodiment of the disclosure, the AI model(s) 160 may be trained on email features and can evaluate the features of the email messages, identify suspicious email messages based on features and/or deviation from ‘normal’ email activities and practices by a source, device or enterprise pertaining to the evaluated email message, and automatically generate results that may initiate alerts or conduct remediation operations on components associated with the malicious activity. Stated differently, some, or all of the AI model(s) 160 may be trained on a normal pattern of life of email activity and user activity associated with an email system. A determination is made of a threat risk parameter that factors in the likelihood that a chain of one or more unusual behaviors of the email activity that may involve data loss characteristics and user activity under analysis fall outside of derived normal benign behavior. If so, the autonomous response module 140 can be used, rather than a human taking an action, to cause one or more autonomous actions to be undertaken to manage the cyber threat and perhaps perform automated remediation.

For example, when the issue relates to data loss prevention (DLP), the remediation measures recommended or automatically performed may include dropping suspicious email messages with potential data loss characteristics at firewalls, blocking transmission of IP address or domains pertaining to targeted recipients of the evaluated email message at a firewall or at the cyber security appliance, etc. Additional remediation measures recommended or automatically performed may include automatically scaling (up or down) allocated compute resources to a particular account through provisioning or terminating EC2 instances, VMs, etc., deleting temporary files or log archives from a machine, providing notifications to SOC teams as to DLP activities and disabling one or more computing associated with the attempted data loss condition, etc.

As an optional feature, in lieu of or in addition to DLP operations by the email protection module 120, the cyber threat analyst module 125 may be configured to conduct analytics on the communications monitored by the cyber security appliance 100. For example, the cyber threat analyst module 125 is configured to conduct analytics on behaviors (user and email activities) to determine if such activities denote cyber threats involving data loss and/or other threat types.

The cyber security appliance 100 can protect an email system with components including the email protection module 120. As shown in FIG. 2, the email protection module 120 may include (i) email classification logic 200; (ii) HA fail-open control logic 220; email threat detector logic 240 including email DLP logic 250 (inbound, outbound, lateral modules), where the email DLP logic 250 is adapted for communication with the email classification logic 200 and Artificial Intelligence based (AI-based) logic such as one or more large language models (LLMs) 185 and/or AI models 160. The email protection module 120 further includes user interface (UI) connection logic 260 and security mailbox assistant logic 270 for feedback generation via the UI connection logic 260. The operations of such logic units are described below.

More specifically, referring back in FIG. 1, the cyber security appliance 100 is configured with modules adapted with DLP functionality to protect against security threats caused through data loss characteristics. The cyber security appliance 100 features (i) a trigger module 105, (ii) a gather module 110, (iii) the email protection module 120, (iv) the cyber threat analyst module 125, (v) an assessment module 130, (vi) a user interface and (display) formatting module 130, (vii) the autonomous response module 140, (viii) a (local) data store 145, (ix) a network module 155, (x) a network & email coordinator module 157, and (xi) the AI models 160A-160D. The AI models 160A-160D include one or more AI models 160A trained on the pattern of life of different users, different devices, email activities, and interactions between entities in the enterprise (which includes AI models that are trained on the normal pattern of life of email activity and user activity associated with at least the email system). Additionally, a second AI model 160B may be trained on features of an email itself and its related data, a third AI model 160C may be trained on potential cyber threats, a fourth AI model 160D may be trained on how to conduct cyber threat investigations including parsing and analysis of email messages.

The trigger module 105, operating in cooperation with the email protection module 120, the network module 155 and the AI model(s) 160, may detect a DLP event (e.g., email message 122 received and processed by the data labeling classification engine 170, an alert based on unusual or suspicious behavior/activity is occurring, etc.). The email protection module 120, further cooperating with the data labeling classification engine 170, AI model(s) 160 and LLM(s) 185, may be configured to conduct analytics on features associated with the email messages 122 such as (i) metadata identifying sensitive information uncovered by the data labeling classification engine 170, (ii) specific content uncovered from analysis of the evaluated email message by the email classification logic 200 (see FIG. 2) and/or LLM(s) 185, and/or (iii) correlation results based on comparison of this email message to normal or expected enterprise-based communications (from enterprise, end user, computing device, department, group of persons, management level, etc.) through interaction with the AI models 160. Thereafter, based on the results, the email protection module 120 may trigger an alert or initiate a remedial action such as preventing transmission of the evaluated email message 122.

Accordingly, the gather module 110 operates in response to the trigger module 105 detecting a specific events and/or alert. The content associated with network communications, which may be used in email message evaluation, may be gathered from the Internet Service Providers (ISPs) and maintained within the local data store 145. Other data that may be useful in the email security analysis (e.g., domain-based metrics, fleet-wide behavioral metrics, etc.) as well as historic data from the local data store 145 may be collected and passed to the email protection module 120 and/or the cyber threat analyst module 125.

According to one embodiment of the disclosure, the email protection module 120, the network module 155, and the network & email coordinator module 157 may be portions of the cyber threat analyst module 125 or separate modules by themselves. In another embodiment of the disclosure, each of the email classification logic 200, HA fail-open control logic 220, email threat detector logic 240, user interface (UI) connection logic 260, and security mailbox assistant logic 270 of FIG. 2 may be separate logic units with the email protection module 120 or may be logic within other components deployed within the cyber security appliance 100.

Additionally, or in the alternative, the email protection module 120, the cyber threat analyst module 125 and/or one or more of the AI models 160A-160D may be configured to receive the domain data. For this deployment, the email protection module 120 and/or the cyber threat analyst module 125 may use the collected domain data to draw an understanding of email activity in the email system as well as updates a training for the one or more AI models 160A trained on this email system and its users. For example, email traffic can be collected by putting probe hooks into the e-mail application, the email server, such as Outlook® or Gmail® email servers, and/or monitoring the internet gateway from which the e-mail messages are routed through.

The email protection module 120 and the network module 155 may be configured to communicate and exchange information with the AI models 160A-160D. Additionally, the cyber threat analyst module 125 cooperates with the AI module(s) 160 to analyze the wide range of metadata from the observed email communications. As described, the email protection module 120 may operate separately to perform email DLP analytics and leverage results from the AI model(s) 160 or operate in combination with the cyber threat analyst module 125 as described below.

For example, the email protection module 120 and/or the cyber threat analyst module 125 can be configured, separately or in combination, to receive an input from one or more of the AI module(s) 160 in the cyber security appliance 100. The email protection module 120 and/or the cyber threat analyst module 125 factors in the input from at least each of these analyses leveraging operations by the AI model 160A in a wide range of metadata from observed email communications to detect and determine when a deviation from the normal pattern of life of email activity and user activity associated with the network and its email domain is occurring. In response to a deviation, the email protection module 120 and/or the cyber threat analyst module 125 cooperates with the autonomous response module 140 to determine what autonomous action to take to remedy against an email message with data loss characteristics. The email protection module 120 and/or the cyber threat analyst module 125 may also reference and communicate with one or more AI models 160C trained on cyber threats in the email system. The email protection module 120 and/or the cyber threat analyst module 125 may also reference the one or more AI models 160B that are trained on the normal features of email messages based on pattern of life of email activity.

The email protection module 120 and/or the cyber threat analyst module 125 can reference these various trained AI models 160A-160D and data from the network module 155, the email protection module 120, and the trigger module 105. The cyber threat analyst module 125 may be configured to assist in determining a threat risk parameter, such as the DLP confidence factor for example, that represents how a chain of unusual behaviors correlate to potential DLP security threats and ‘what is a likelihood of this chain of one or more unusual behaviors of the email activity and user activity under analysis that fall outside of derived normal benign behavior;’ and thus, is suspicious behavior.

Any or all of the AI models 160A-160D can be self-learning models using unsupervised learning and trained on a normal behavior of different aspects of the system, for example, email activity and user activity associated with an email system. The self-learning models of normal behavior (e.g., AI model(s) 160A) are regularly updated. The self-learning model of normal behavior is updated when new input data is received that is deemed within the limits of normal behavior. A normal behavior threshold is used by the model as a moving benchmark of parameters that correspond to a normal pattern of life for the email system. The normal behavior threshold is varied according to the updated changes in the email system allowing the model to spot behavior on the email system that falls outside the parameters set by the moving benchmark.

Referring still to FIG. 1, the cyber security appliance 100 may also include one or more AI models 160B trained on gaining an understanding of a plurality of features on an email itself and its related data including classifying the properties of the email and its metadata. The email protection module 120 and/or the cyber threat analyst module 125 can also reference the AI model(s) 160B trained on an email message itself and its related data to determine if an email message or a set of email messages under analysis have potentially data loss characteristics. The email protection module 120 and/or the cyber threat analyst module 125 can also reference the AI model(s) 160C trained on cyber threats and their characteristics and symptoms to determine if an email message or a set of email messages under analysis may involve data loss. The email protection module 120 and/or the cyber threat analyst module 125 can also factor this email feature analysis into its determination of the security risk parameter such as the DLP confidence score.

The network module 155 cooperates with the AI model(s) 160A trained on a normal behavior of users, devices, and interactions between them within the enterprise, which is tied to the email system. The email protection module 120 and/or the cyber threat analyst module 125 can also factor this analysis into its determination of the security risk parameter.

A user interface has one or more windows to display network data and one or more windows to display email messages and cyber security details about those email messages through the same user interface on a display screen, which allows a security administrator to pivot between different cyber security details, such as network data and email security, within one platform, and consider them as an interconnected whole rather than separate realms on the same display screen.

According to the embodiment illustrate in FIG. 1, the cyber security appliance 100 may use at least four separate AI models 160A-160D. The AI model(s) 160A may be trained on specific aspects of the normal pattern of life for the system such as devices, users, network traffic flow, outputs from one or more cyber security analysis tools analyzing the system, etc. The AI model(s) 160B may be trained on specific features of an email message positioned within different segments of the message (e.g., header, body, attachment). The AI model(s) 160C may also be trained on characteristics and aspects of all manner of types of cyber threats and/or characteristics of email messages themselves. The AI model(s) 160D may be trained on how and operations to perform when conducting cyber threat investigations and/or cyber threat analytics.

The email protection module 120 is configured to monitor email activity and the network module 155 is configured to monitor network activity, where both of these modules may be fed their data to a network & email coordinator module 157 to correlate causal links between these activities to supply this input into the cyber threat analyst module 125.

Again, the cyber threat analyst module 125 is configured to receive an input from at least each of the two or more modules above. The cyber threat analyst module 125 may be configured to factor in the input from each of these analyses above to use a wide range of metadata from observed email communications to at least assist in detecting and determining when the deviation from the normal pattern of life of email activity and user activity associated with the network and its email domain is occurring, and then determine what autonomous action to take to remedy against a potentially malicious email. Again, the cyber threat analyst module 125 may factor in the input from each of these analyses above including comparing email messages to the AI model trained on characteristics of an email itself and its related data to detect and determine when the deviation indicates a potentially malicious email.

The email protection module 120 and/or the cyber threat analyst module 125 detect deviations from a normal pattern of life of email activity and user activity associated with the network and its email domain based on at least one or more AI models determining the normal pattern of life of email activity and user activity associated with the network and its email domain; rather than, ahead of time finding out what a ‘bad’ email signature looks like and then preventing that known bad’ email signature.

Based on analytic results from the email protection module 120 and/or the cyber threat analyst module 125, the cyber security appliance 100 takes actions to counter detected potential cyber threats. The autonomous response module 140, rather than a human taking an action, can be configured to cause one or more autonomous actions to be taken to contain the cyber-threat when the security risk parameter from the email protection module 120 and/or the cyber threat analyst module 125 is equal to or above an actionable threshold. The email protection module 120 and/or the cyber threat analyst module 125 cooperates with the autonomous response module 140 to cause one or more autonomous actions to be taken to contain the cyber threat, in order to improve computing devices in the email system by limiting an impact of the cyber-threat from consuming unauthorized CPU cycles, memory space, and power consumption in the computing devices via responding to the cyber-threat without waiting for some human intervention.

Referring to FIG. 2, a block diagram of the email protection module 120 deployed within the cyber security appliance of FIG. 1 is shown. The email protection module 120 is designed to conduct pattern of life analyses unique to each mailbox and/or each enterprise, identify potential data loss characteristics (i.e., loss, leakage, or misuse of sensitive information), and conduct DLP operations to prevent the release of outbound email messages. The DLP analytics may differ for distinct types of email messages. For example, DLP analytics for outbound email messages may apply different weightings to results or features provided by different sources (e.g., classifier(s), LLM(s), AI model(s), etc.) or may conduct different ‘pattern of life’ analyses given the outward transmission path (external from enterprise) of the email message in lieu of a lateral transmission path (internal and remaining within the enterprise).

Herein, according to this embodiment, the email protection module 120 includes (i) email classification logic 200; (ii) HA fail-open control logic 220; (iii) email threat detector logic 240, which includes email DLP logic 250 adapted to communicate with the email classification logic 200, cyber threat analyst module 125 of FIG. 1, and/or Artificial Intelligence based (AI-based) logic such as one or more large language models (LLMs) 185 and/or AI models 160. The email protection module 120 further includes user interface (UI) connection logic 260 for connectivity to user interface and formatting module 130 for generation of UI displays provided over I/O ports, and security mailbox assistant logic 270 for feedback generation via the UI connection logic 260.

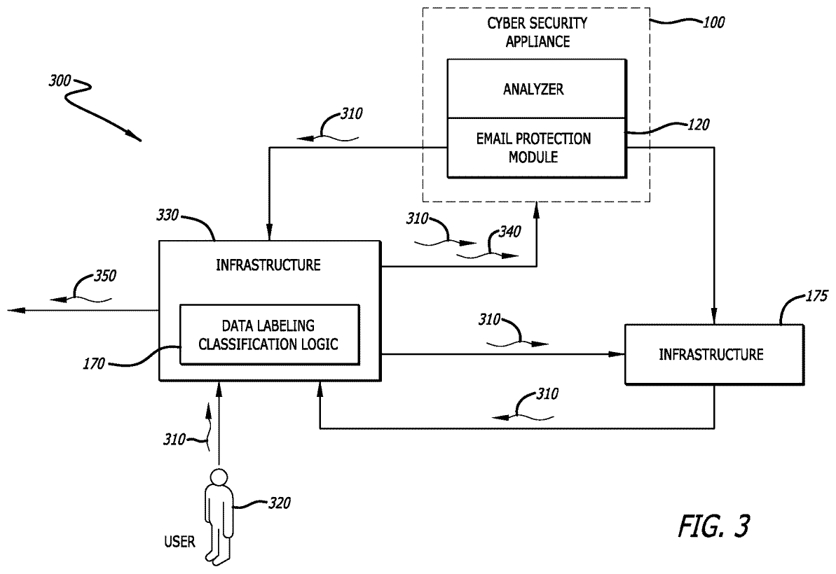

More specifically, the HA fail-open control logic 220 configured to avoid the email protection module 120 from operating as a single point of failure. In particular, the HA fail-open control logic 220 may be adapted to detect operational failure of the email protection module 120 or disruption of an Application Programming Interface (API) providing access to output from the data labeling classification engine 170 of FIG. 1, namely an evaluated email message along with metadata identifying sensitive information associated with that email message. Upon detecting the operational failure or email message intake disruption, the email message will be redirected to the HA infrastructure 175 within a cloud environment associated with the enterprise. As a result, the HA fail-open control logic 220 is configured to prevent an enterprise-wide disruption of outbound email messages in response to failure of an email flow loop 300 (see FIG. 3) by signaling the data labeling classification engine 170 to temporarily route at least outbound email messages to the HA infrastructure 175 operating as an email message queue that permits transmission of the outbound email messages after imposing a brief ‘hold’ of each outbound email message.

Herein, the email classification logic 200 is adapted to communicate with the data labeling classification engine 170 of FIG. 1 via an API 210. The email classification logic 200 is configured to collect evaluated email messages along with metadata identifying potential presence of sensitive information determined by the data labeling classification engine 170 and conduct further parsing of the email message to determine various parameters associated with the email message. For example, the email classification logic 200 may be configured to determine whether the recipient and sender share the same email domain of the enterprise to denote a lateral email message, or the sender email address features the enterprise email domain address while the recipient is directed to a different email domain to denote an outbound email message. The email classification logic 200 performs analytics to gather specific features associated with the email message under evaluation while the LLM(s) 185 may be utilized to gather context and other features that may be more easily identified through natural language processing (NPL).

The email threat detector logic 240 includes email DLP logic 250, which is configured to conduct real-time analytics on content associated with evaluated email message for potential data loss characteristics, such as accidental or intentional exfiltration of sensitive data for example. For this embodiment, the email DLP logic 250 is adapted to conduct analytics on outbound email messages and/or lateral email messages, which may be determined by analysis, by classifier(s) and/or LLM(s) of content within the evaluated email message such as the sender/recipient data (e.g., an outbound message when the sender/recipient are in different email domains or a lateral message when the sender/recipient are in the same email domain.

More specifically, the real-time analytics performed by the email DLP logic 250 may involve analyses on various features associated with that email message received from different sources including classifier(s), LLM(s) and/or AI model(s). The features may include (i) metadata identifying sensitive information uncovered by the data labeling classification engine, (ii) specific content uncovered from analysis of the evaluated email message that may provide further context surrounding the message (e.g., message type—outbound/lateral; size or time that may suggest exfiltration, etc.), and/or (iii) correlation results based on comparison of this evaluated email message to normal or expected enterprise-based communications (within or from an enterprise, end user, computing device, or group of persons such as a department, team, management or executive personnel, etc.).

As an illustrative example, uncovered from parsing the content of an evaluated email message, the uncovered features may include features pertaining to content within a header of the evaluated email message (e.g., sender, recipient, time, subject line details, size, etc.), features pertaining to content within a body portion of the evaluated email message (e.g., context as to how which the potential sensitive information is used, keywords or phrases that indicative the sensitive nature of the context associated with any attachments, etc.), and/or features pertaining to content within any attachment (e.g., information to infer context associated with the message—reason, actual subject independent of the details listed in the subject line, etc.).

Additionally, the features corresponding to correlation results may be based on a comparison of features associated with the evaluated email message representing behavioral characteristics associated with an enterprise, end user, computing device, or group of persons against normal patterns of email activity (i.e., pattern-of-life) by the enterprise, end user, computing device, and/or group of persons. The normal patterns of email activity may be provided by AI model(s) 160 deployed within the cyber security appliance 100. The results of this comparison (correlation results) may be provided to the email DLP logic 250.

Thereafter, based on receipt of features from different input sources, the email DLP logic 250 is configured to conduct DLP operations in real time by analyzing these features to generate (or assist the cyber threat analyst module 125 in generating) a DLP confidence score to identify whether a data loss condition exists and what action, if any, is warranted when the DLP confidence score exceeds a prescribed threshold value. Herein, the email DLP logic 250 may be configured to apply a different set of weightings based on the type of evaluated email message (outbound or lateral) and/or the type of potential data loss characteristics (e.g., accidental data loss such as incorrect email recipient typed, or wrong attachment sent or malicious data loss such as a security breach and targeted exfiltration of data). For example, the DLP analysis for outbound email messages may weigh features associated with LLM context analysis and the ‘time’ feature more heavily than other features while the DLP analysis for lateral email messages may give greater weight to features associated with the payload, such as content associated with the attachments or links within the body of the lateral email message. Any outbound or lateral email messages that failed the DLP analytics (i.e., DLP confidence score exceeds the prescribed threshold value) would be halted from transmission from the enterprise by the cyber security appliance 100 or a firewall operating in concert with the cyber security appliance 100.

As stated above, the DLP operations may differ depending on the type of data loss: accidental data loss or malicious data loss. For example, accidental data loss is generally more difficult to detect because the data loss may be directed to a situation where an outbound email message is being sent to the wrong end user. Hence, the DLP operations associated with accidental data loss may be more focused on the recipient information especially in connection with similarities of spelling of known contacts, understanding of topics normally involved in communications between the contacts, and typical communication times (e.g., during morning, normal working hours, etc.). DLP operations associated with malicious data loss may be more focused on the size of the email messages, learned context representing the environment or conditions that influence the content within the body and/or attachments of the evaluated email message, the type of data being exfiltrated, or the like.

Additionally, the cyber security appliance 100 is configured with UI connection logic 260 and/or security mailbox assistant logic 270 adapted to provide a mechanism that enhances feedback responses to an end user reporting an email security threat (e.g., an attempted data exfiltration) via the user interface and formatting module 130 of the cyber security appliance 100 (see FIG. 1). Such enhancements may be based on a feedback message to the end user identifying receipt of the evaluated email message submitted by the end user along with (or followed by) additional messages to identify whether the evaluated email message constituted a data loss security threat and/or a brief explanation of the notable factors as to why this email message warranted DLP action. The brief explanation may be generated by the LLM(s) 185 as part of the analysis results provided to the email protection module 120. The feedback message(s) are configured to encourage end users to adopt good security practices.

Furthermore, the email protection module 120 is further configured to provide the security mailbox assistant logic 270, which offers end users new ways to engage with the SOC team and report suspicious email messages. The security mailbox assistant logic 270 is adapted to provide feedback to an end user reporting an email security threat (e.g., an attempted data exfiltration) within a few seconds, which encourages users to adopt good security practices. The email protection module 120 can automate SOC team actions such as removing the evaluated email message reported by the end user as well as similar email messages present in mailboxes of other users until the SOC team has been able to investigate the reported, evaluated email message. The email protection module 120 can further automate investigations and workflows. For example, when end users report an email message as potentially suspicious, the email protection module 120 may be configured to automatically launch an in-depth investigation, automating SOC team's triage workflow.

The email threat detector logic 240 of the email protection module 120 cooperates with the autonomous response module 140 to predict a sustained and malicious email campaign by analyzing, for example, based on data loss characteristics and conduct an automated response. A sustained, email campaign of actually malicious email messages may be predicted by analyzing the type of action taken by the autonomous response on a set of evaluated email messages with detected data loss characteristics, such as precluding further propagation of the evaluated email message, and factoring in a ‘pattern of life’ associated with such user or email activity.

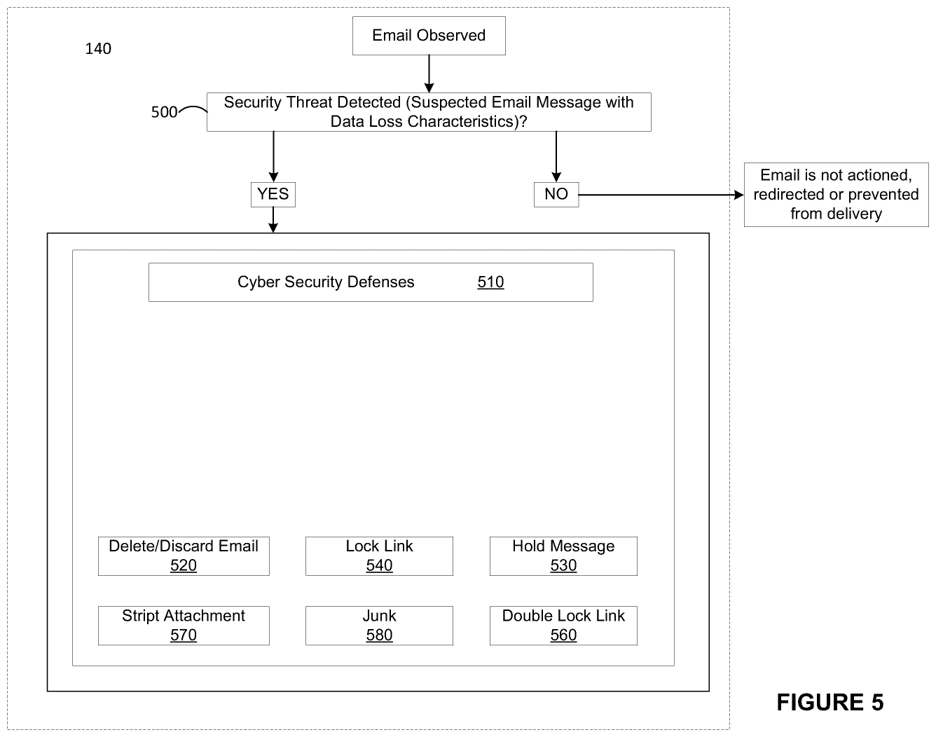

Referring to FIGS. 1-2, one or more AI models 160A-160C communicatively couple to the email threat detector logic 240. The one or more AI models 160A-160C are configured to conduct DLP analytics on evaluated email messages and then output results in response to detecting data loss characteristics associated with the evaluated email messages. The email threat detector logic 240 is configured to cooperate with the one or more AI models, such as AI models 160A-160B for example, to identify email messages that are deemed malicious. Actions performed by the autonomous response module 140 are decided on an email-by-email basis and include, for example, preventing transmission by holding a message for further investigation or sending it to the junk folder. Other actions may include disabling hyperlinks, removal of attachments, etc. before delivery to the recipient's mailbox (see FIG. 5).

The email threat detector logic 240 can look at time periods within a given time frame to detect pretty quickly whether this email network being protected is getting a campaign of email messages building up and occurring, by looking at and comparing to the machine learning averages as well as the mathematical means and median values, etc. to the current numbers. The email threat detector logic 240 can detect, for example, an uptick in email messages with data loss characteristics along with an uptick in autonomous responses indicative of building up to accidental data loss (e.g., repetitive end user error) or malicious data loss (e.g., an ongoing email attack campaign with data exfiltration). The uptick in autonomous responses by the autonomous response module 140 may be provided as a factor to the email threat detector logic 240 in its DLP analytics of an evaluated email message.

Referring now to FIG. 3, a flow diagram of illustrative operations conducted in accordance with an email flow loop 300 inclusive of the email protection module 120 deployed within the cyber security appliance 100 and a data labeling classification engine 170 of FIG. 1. In particular, an email message 310 prepared by an end user 320 is received by the data labeling classification engine 170 such as Microsoft® Purview® being a service integrated with Microsoft® 365 infrastructure 330. The data labeling classification engine 170 parses the email message 310 and attempts to identify sensitive information therein. The sensitive information may include information predicted by the data labeling classification engine 170 to be confidential (e.g., financials, documents with confidential headings or watermarked confidentiality, etc.) or personally identifiable information (PII).

Thereafter, the email message 310 along with metadata 340 associated with uncovered sensitive information is routed to the email protection module 120 of the cyber security appliance 100 to conduct DLP operations to identify outbound or lateral email messages with potential data loss characteristics. If there is no identified data loss characteristics, the email message 310 is returned to the Microsoft® 365 infrastructure 330 for transmission as an outbound or lateral email message 350. If DLP analytics by the email protection module 120 determines that the transmission of the email message 310 would result in accidental data loss (e.g., errand transmission) or malicious data loss (e.g., security breach), an action is performed on the email message 310 by the autonomous response module 140 of FIG. 1 within the cyber security appliance 100, such as withholding return of the email message 310 to the Microsoft® 365 infrastructure 330 until SOC team review.

Given that the email protection module 120 could act as a single failure point, namely email messages would be precluded from transmission from an enterprise upon failure of the email protection module 120, the email flow loop 300 feature features high availability (HA) infrastructure 175 communicatively coupled to the data labeling classification engine 170. The HA infrastructure 175 is fail-open, meaning that the email message 310 is routed to the HA infrastructure 175 in response to inoperability (failure) of the email protection module 120. As a result, the HA infrastructure 175 temporarily holds the email message 310 for a prescribed period of time, and after such time has elapsed, releases the email message 310 back to the Microsoft® 365 infrastructure 330 for transmission as the outbound or lateral email message 350.

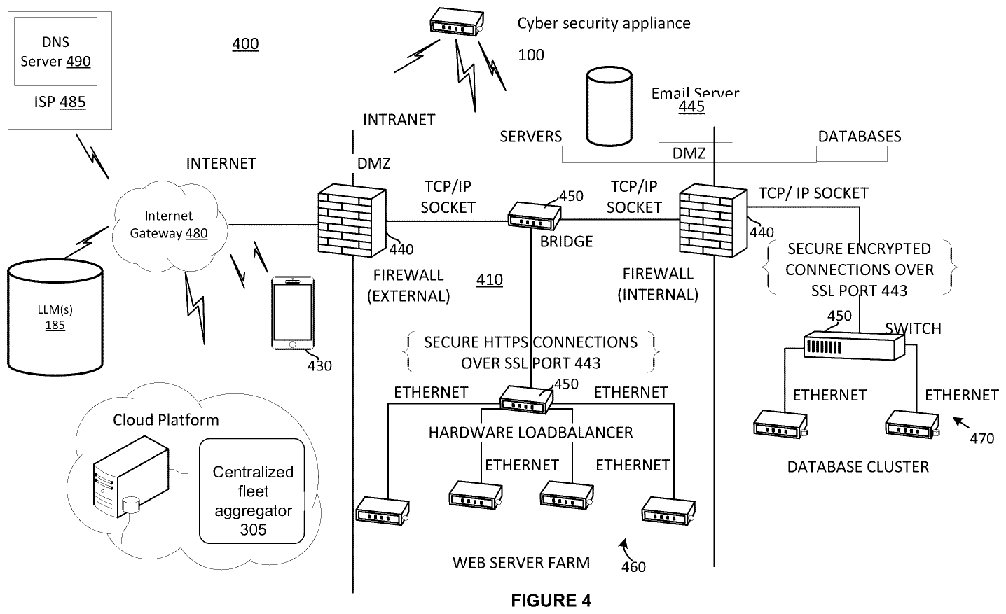

Referring now FIG. 4, a block diagram of an exemplary embodiment of a cyber security platform 400 with the cyber security appliance 100 adapted to conduct DLP analytics on email messages to monitor email message content and email message activity that suggest a data loss condition with assistance from LLM(s) 185 and the data labeling classification engine 170 illustrated as a cloud service is shown. The cyber security appliance 100 may be hosted on a computing device, on one or more servers, and/or in its own cyber-threat appliance platform. Also, the data labeling classification engine 170 may be part of the operating system within the cyber security appliance 100.

Herein, the cyber security appliance 100 operates to monitor attempted email message transmissions and/or network activity over a network system 410. The network system 410 may include the cyber security appliance 100 that is communicatively coupled to various computing devices 430 (e.g., desktop computer(s), laptop computer(s), smart phone(s), smart watch(es), wearable(s), etc.), firewall(s) 440, network infrastructure 450 (e.g., switches, routers, bridges, etc.), server(s) 460, database(s) 470, and/or Internet gateway(s) 480 for communicatively coupling to the ISP(s) 485, DNS server 490. The cyber security appliance 100 is communicatively coupled to the enterprise's email server (system) 445, where the data labeling classification engine 170 may be an intermediary component within such communications.

Herein, as shown in FIGS. 1 and 4, the cyber security appliance 100 includes the email protection module 120, which uses probes, including a set of detectors, to monitor email activity. Likewise, the network module 155 uses the probes, including a set of detectors, to monitor network activity and can reference the AI model(s) 160 to identify unusual network activity by users, computing devices, and interactions between them or the Internet which is subsequently tied to the email system. Information associated with the monitored network activity provides an additional input to the cyber threat analyst module 125 in order to determine the security risk (e.g., the DLP confidence score) indicative of the DLP threat level. A particular user's network activity may be highly correlated to email activity because the network module 155 observes network activity, and the network & email coordinator module 157 may assess particular user's email activity based on information from the email protection module 120 to make an appraisal of potential email threats with a resulting threat risk parameter tailored for different users in the email system. The network module 155 tracks each user's network activity and sends that to the network & email coordinator module 157 to interconnect the network activity and email activity to closely inform one another's behavior and appraisal of potential email threats.

Referring to FIG. 5, an illustrative block diagram of an exemplary embodiment of autonomous actions automatically conducted by the autonomous response module 140 of FIG. 1 without a human initiating that action is shown. The autonomous response module 140 is configurable, via a user interface, to know when it should take the autonomous actions to contain a cyber threat when malicious activity is determined by the email protection module 120 or the cyber threat analyst module 125. According to one embodiment, the autonomous response module 140 operates as an administrative tool, configurable through the user interface, to program/set what autonomous actions are to be performed in response to signaling from the email protection module 120 and/or cyber threat analyst module 125 that an evaluated email message with data loss characteristics has been detected i.e. DLP confidence score greater than threshold value (block 500).

The following selection of example actions to be performed in response to the email protection module 120 conducting DLP analytics and identifying a potential security threat (data loss condition) based on the DLP analytics. These actions may be categorized as cyber security defensive actions 510.

More specifically, the cyber security defensive actions 510 may include remediation actions to fortify cyber security defenses of computing devices associated with the cyber security platform 400 of FIG. 4 associated with the monitored enterprise domain. These cyber security defensive actions 510 may include deletion of the evaluated email message identified with data loss characteristics i.e., a data loss condition (delete action 520) as well as other actions categorized as delivery actions, attachment actions, link actions, header, and body actions, etc., which appear on the dashboard and can be taken by or at least suggested to be taken by the autonomous response module 140 when the threat risk parameter is equal to or above a configurable set point set by a domain administrator. Examples of these other actions are described below.

Hold Message 530: The autonomous response module 140 has held the message before delivery due to suspicious content or attachments. Held email messages can be reprocessed and released by an operator after investigation. The email message will be prevented from delivery, or if delivery has already been performed, removed from the recipient's inbox. The original email message will be maintained in a buffered cache by the data store and can be recovered, or sent to an alternative mailbox, using the ‘release’ button in the user interface.

Lock Link 540: The autonomous response module 140 replaces the URL of a link such that a click of that link will first divert the user via an alternative destination. The alternative destination may optionally request confirmation from the user before proceeding. The original link destination and original source will be subject to additional checks before the user is permitted to access the source.

Convert Attachment 550: The autonomous response module 140 converts one or more attachments of this email message to a safe format, flattening the file typically by converting into a PDF through initial image conversion. This delivers the content of the attachment to the intended recipient, but with vastly reduced risk. For attachments which are visual in nature, such as images, PDFs and Microsoft Office formats, the attachments will be processed into an image format and subsequently rendered into a PDF (in the case of Microsoft Office formats and PDFs) or into an image of the original file format (if an image). In some email systems, the email attachment may be initially removed and replaced with a notification informing the user that the attachment is undergoing processing. When processing is complete the converted attachment will be inserted back into the email.

Double Lock Link 560: The autonomous response module 140 replaces the URL with a redirected Email link. If the link is clicked, the user will be presented with a notification to that user that they are not permitted to access the original destination of the link. The user will be unable to follow the link to the original source, but their intent to follow the link will be recorded by the data store via the autonomous response module 140.

Strip Attachments 570: The autonomous response module 140 strips one or more attachments of this email. Most file formats are delivered as converted attachments; file formats which do not convert to visible documents (e.g., executables, compressed types) are stripped to reduce risk. The ‘Strip attachment’ action will cause the system to remove the attachment from the email and replace it with a file informing the user that the original attachment was removed.

Junk action 580: The autonomous response module 140 will ensure the email classified as junk or other malicious email is diverted to the recipient's junk folder, or other nominated destination such as ‘quarantine’.

Referring to both FIG. 1 and FIG. 5, the types of actions and specific actions conducted by the autonomous response module 140 may be customizable for different users and parts of the system; and thus, configurable for the domain administrator to approve/set for the autonomous response module 140 to automatically take those actions and when to automatically take those actions.

For instance, the autonomous response module 140 may have access to a library of response action types of actions and specific actions the autonomous response module 140 is capable of, including focused response actions selectable through the user interface that are contextualized to autonomously act on email messages that have failed DLP analytics, rather than a blanket quarantine or block approach on that email message, to avoid business disruption to a particular user of the email system. The autonomous response module 140 is able to take measured, varied actions towards those email communications to minimize business disruption in a reactive, contextualized manner.

The autonomous response module 140 may work hand-in-hand with the AI model(s) 160 to neutralize malicious email messages, and deliver preemptive protection against targeted, email-borne attack campaigns in real time.

The cyber threat analyst module 125 cooperating with the autonomous response module 140 can detect and contain, for example, an infection in the network, recognize that the infection had an email as its source, and identify and neutralize that malicious email by either removing that from the corporate email account inboxes, or simply stripping the malicious portion of that before the email reaches its intended user. The autonomous actions range from flattening attachments or stripping suspect links, through to holding email messages back entirely if they pose a sufficient risk.

The cyber threat analyst module 125 can identify the source of the compromise and then invoke an autonomous response action by sending a request to the autonomous response model. This autonomous response action will rapidly stop the spread of an emerging attack campaign and give human responders the crucial time needed to catch up.

In an embodiment, initially, the autonomous response module 140 can be run in human confirmation mode—all autonomous, intelligent interventions should be confirmed initially by a human operator. As the autonomous response module 140 refines and nuances its understanding of an organization's email behavior, the level of autonomous action can be increased until no human supervision is required for each autonomous response action. Most SOC (security) teams will spend little time in the user interface once this level is reached. At this time, the autonomous response module 140 response action neutralizes email messages with an accidental or malicious data loss characteristics without the need for any active management. Suspect DLP-violating email messages can be held in full, autonomously with selected users exempted from this policy, for further inspection or authorization for release. User behavior and notable incidents can be mapped, and detailed, comprehensive email logs can be filtered by a vast range of metrics compared to the model of normal behavior to release or strip potentially malicious content from the email message.

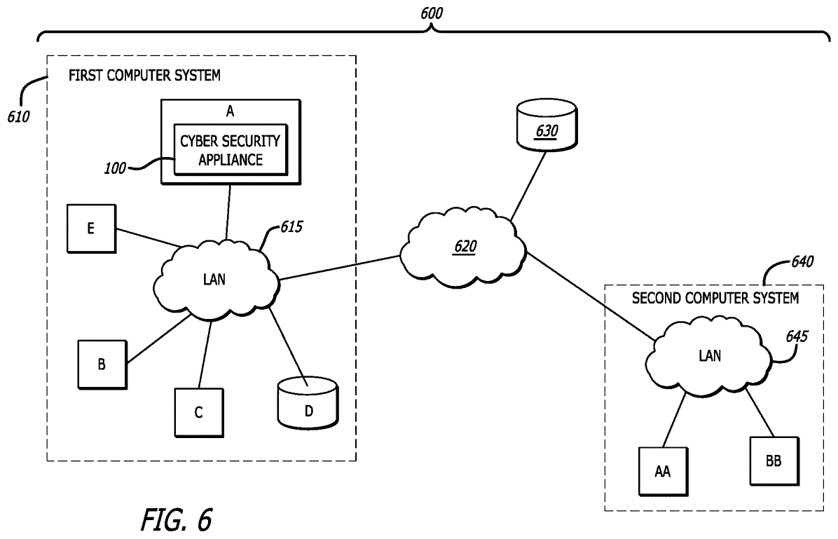

Referring now to FIG. 6, an example of the AI-based cyber security appliance 100 using the email protection module 120 and/or the cyber threat analyst module 125 to protect an example network is illustrated. The network 600 uses a cyber security appliance 100. The system depicted is a simplified illustration, which is provided for ease of explanation. The network 600 comprises a first computer system 610 within a building, which uses the DLP analytics for email messages to detect security threats associated with data loss characteristics and thereby attempt to prevent these security threats.

The first computer system 610 comprises three computers A, B, C, a local server D, and a multifunctional device E that provides printing, scanning and facsimile functionalities to each of the computers A, B, C. All of the devices within the first computer system 610 are communicatively coupled via a Local Area Network 615. Consequently, all of the computers A, B, C are able to access the local server D via the LAN 615 and use the functionalities of the multifunctional device E via the LAN 615.

The LAN 615 of the first computer system 610 is connected to the Internet 620, which in turn provides computers A, B, C with access to a multitude of other computing devices including server 630 and second computer system 640. The second computer system 640 also includes two computers AA, BB, connected by a second LAN 645.

In this exemplary embodiment of the cyber security appliance 100, computer A on the first computer system 610 includes electronic hardware, modules, models, and various software processes of the cyber security appliance 100; and therefore, runs DLP operations for detecting security (DLP) threats to the first computer system 610. As such, the first computer system 610 effectively includes one or more processors arranged to run the steps of the process described herein, memory storage components required to store information related to the running of the process, as well as a network interface for collecting the required information for the probes and other sensors collecting data from the network under analysis.

The cyber security appliance 100 in computer A builds and maintains a dynamic, ever-changing model of the ‘normal behavior’ of each user and machine within the first computer system 610. The approach is based on Bayesian mathematics, and monitors all interactions, events, and communications within the first computer system 610—which computer is talking to which, files that have been created, networks that are being accessed.

For example, computer B may be based in a company's San Francisco office and operated by a marketing employee who regularly accesses the marketing network, usually communicates with machines in the company's U.K. office in second computer system 640 between 9.30 AM and midday, and is active from about 8:30 AM until 6 PM.

The same employee virtually never accesses the employee time sheets, very rarely connects to the company's Atlanta network, and has no dealings in South-East Asia. The cyber security appliance 100, notably the email protection module 120 of FIG. 1, takes all the information that is available relating to this employee and establishes a ‘pattern of life’ for that person and/or the computing device(s) used by that person, which is dynamically updated as more information is gathered. The model of the normal pattern of life for an entity in the network under analysis is used as a moving benchmark, allowing the cyber security appliance 100 to spot behavior by the person and/or computing device that seems to fall outside of this normal pattern of life, and flags this behavior as anomalous, requiring further investigation and/or autonomous action.

The cyber security appliance 100 is built to deal with the fact that today's attackers are getting stealthier, and an attacker/malicious agent may be ‘hiding’ in a system to ensure that they avoid raising suspicion in an end user, such as by slowing their machine down.

The AI model(s) 160 in the cyber security appliance 100 builds a sophisticated ‘pattern of life’—that understands what represents normality for every person, device, and network activity in the system being protected by the cyber security appliance 100.

The self-learning algorithms in the AI can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository.

The email protection module 120 is adapted with self-learning AI can learn “on the job” from real-world data occurring in the system and constantly evolves its understanding as the system's environment changes. The Artificial Intelligence deployed within or accessible to the cyber security appliance 100 can use machine learning algorithms to analyze patterns and ‘learn’ what is the ‘normal behavior’ of the network by analyzing data on the activity on the network at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised Learning can break down features of what it is analyzing (e.g., a network node of a device or user account), which can be useful for categorization, and then identify what else has similar or overlapping feature sets matching to what it is analyzing.

The cyber security appliance 100 can use unsupervised machine learning to works things out without pre-defined labels. In the case of sorting a series of different entities, such as animals, the system analyzes the information and works out the different classes of animals. This allows the system to handle the unexpected and embrace uncertainty when new entities and classes are examined. The modules and models of the cyber security appliance 100 do not always know what they are looking for, but can independently classify data and detect compelling patterns.

The unsupervised machine learning methods conducted by the cyber security appliance 100 do not require training data with pre-defined labels. Instead, they are able to identify key patterns and trends in the data or rely on third party solutions (e.g., data labeling classification engine 170 of FIG. 1) without the need for human input. The advantage of unsupervised learning in this system is that it allows the email protection module 120 to go beyond what their programmers already know and discover previously unknown relationships. The unsupervised machine learning methods can use a probabilistic approach based on a Bayesian framework. The machine learning allows the cyber security appliance 100 to integrate a vast number of weak indicators/low threat values by themselves of potentially anomalous network behavior to produce a single clear overall measure of these correlated anomalies to determine how likely a network device is to be compromised. This probabilistic mathematical approach provides an ability to understand valuable information, amid the noise of the network—even when it does not know what it is looking for.

The cyber security appliance 100 can use a Recursive Bayesian Estimation to combine these multiple analyzes of different measures of network behavior to generate a single overall/comprehensive picture of the state of each device, the cyber security appliance 100 takes advantage of the power of Recursive Bayesian Estimation (RBE) via an implementation of the Bayes filter.

Using RBE, the AI models 160 of the cyber security appliance 100 are able to constantly adapt themselves, in a computationally efficient manner, as new information becomes available to the system. The AI models 160 continually recalculate threat levels in the light of new evidence, identifying changing attack behaviors where conventional signature-based methods fall down.

Training a model can be accomplished by having the model learn good values for all of the weights and the bias for labeled examples created by the system, and in this case; starting with no labels initially. A goal of the training of the model can be to find a set of weights and biases that have low loss, on average, across all examples.

AI classifier solutions can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The model representing normal behavior from a given normal training data set can detect anomalies by establishing the normal pattern and then evaluate the likelihood of a test instance under analysis to be generated by the model. Anomaly detection can identify rare items, events or observations which raise suspicions by differing significantly from the majority of the data, which includes rare objects as well as things like unexpected bursts in activity.

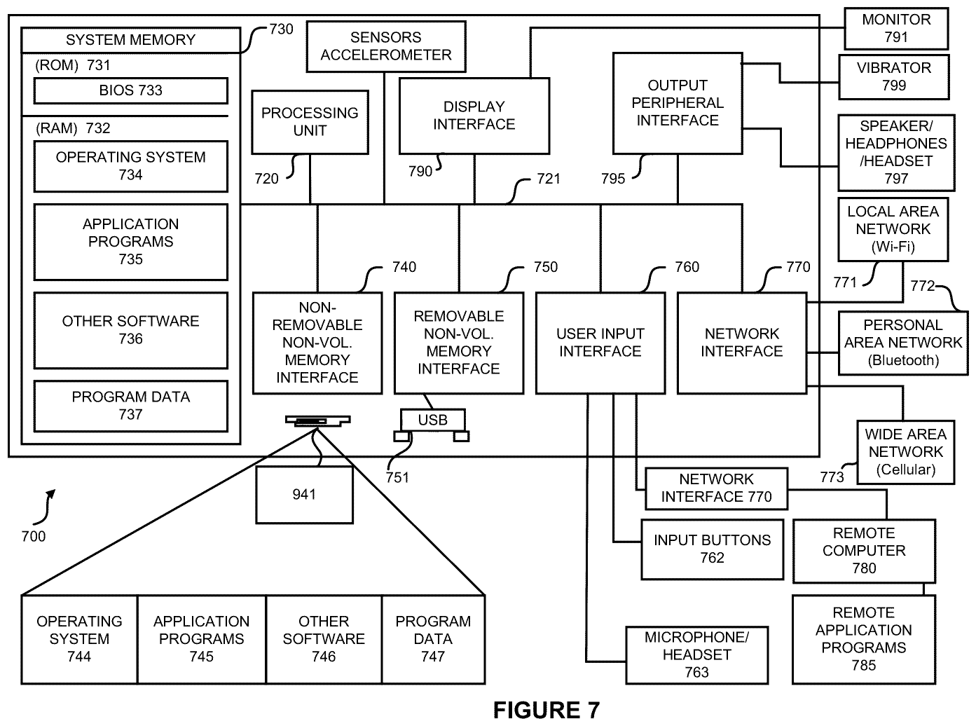

Referring to FIG. 7, an illustrative block diagram of an embodiment of one or more computing devices that can be a part of an embodiment of the AI-based cyber security appliance 100 discussed is shown. Herein, the computing device may include one or more processors 720 to execute instructions, one or more memories 730-732 to store information, one or more data input components 760-763 to receive data input from a user of the computing device 700, one or more modules that include the management module, a network interface communication circuit 770 to establish a communication link to communicate with other computing devices external to the computing device, one or more sensors where an output from the sensors is used for sensing a specific triggering condition and then correspondingly generating one or more preprogrammed actions, a display monitor 791 to display at least some of the information stored in the one or more memories 730-732 and other components. Note, portions of this design implemented in software 744, 745, 746 are stored in the one or more memories 730-732 and are executed by the one or more processors 720. The processor(s) 720 may have one or more processing cores, which couples to a system bus 721 that couples various system components including the system memory 730. The system bus 721 may be any of several types of bus structures selected from a memory bus, an interconnect fabric, a peripheral bus, and a local bus using any of a variety of bus architectures.

Computing device 700 typically includes a variety of non-transitory storage medium. The non-transitory storage medium can be any available media that can be accessed by computing device 700 and includes both volatile and nonvolatile media, and removable and non-removable media. By way of example, and not limitation, the non-transitory storage medium may include, but is not limited to, a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, or other memory technologies), a solid-state storage, a hard disk storage, an optical disc storage, a portable memory device, or storage instances.

The methods and systems shown in the Figures and discussed in the text herein can be coded to be performed, at least in part, by one or more processing components with any portions of software stored in an executable format on a non-transitory storage medium. Thus, any portions of the method, apparatus and system implemented as software can be stored in one or more non-transitory storage mediums in an executable format to be executed by one or more processors.

A network system can be, wholly or partially, part of one or more of the server or client computing devices in accordance with some embodiments. Components of the network system can include, but are not limited to, a processing unit having one or more processing cores, a system memory, and a system bus that couples various system components including the system memory to the processing unit.

In an example, a volatile memory drive 741 is illustrated for storing portions of the software such as operating system 744, application programs 745, other executable software 746, and program data 747.

A user may enter commands and information into the computing device 700 through input devices such as a keyboard, touchscreen, or software or hardware input buttons 762, a microphone 763, a pointing device and/or scrolling input component, such as a mouse, trackball, or touch pad 761. The microphone 763 can cooperate with speech recognition software. These and other input devices are often connected to the processor 720 through a user input interface 760 that is coupled to the system bus 721, but can be connected by other interface and bus structures, such as a lighting port, game port, or a universal serial bus (USB). A display monitor+

or other type of display screen device is also connected to the system bus 721 via an interface, such as a display interface 790. In addition to the display monitor 791, computing devices may also include other peripheral output devices such as speakers 797, a vibration device 799, and other output devices, which may be connected through an output peripheral interface 795.

The computing device 700 can operate in a networked environment using logical connections to one or more remote computers/client devices, such as a remote computing device 780. The remote computing device 780 can a personal computer, a mobile computing device, a server, a router, a network PC, a peer device, or other common network node, and typically includes many or all of the elements described above relative to the computing device 700. The logical connections can include a personal area network (PAN) 772 (e.g., Bluetooth®), a local area network (LAN) 771 (e.g., Wi-Fi), and a wide area network (WAN) 773 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 700 is connected to the LAN 771 through the network interface communication circuit 770, which can be, for example, a Bluetooth® or Wi-Fi adapter. When used in a WAN networking environment (e.g., Internet), the computing device 700 typically includes some means for establishing communications over the WAN 773. With respect to mobile telecommunication technologies, for example, a radio interface, which can be internal or external, can be connected to the system bus 721 via the network interface communication circuit 770, or other appropriate mechanism. In a networked environment, other software depicted relative to the computing device 700, or portions thereof, may be stored in the remote memory storage device. By way of example, and not limitation, remote application programs 785 as reside on remote computing device 780. It will be appreciated that the network connections shown are examples and other means of establishing a communications link between the computing devices that may be used. It should be noted that the present design can be conducted on a single computing device or on a distributed system in which different portions of the present design are conducted on different parts of the distributed network system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A module is a core component of a complex system consisting of hardware and/or software that is capable of performing its function discretely from other portions of the entire complex system but designed to interact with the other portions of the entire complex system. Note, many functions performed by electronic hardware components can be duplicated by software emulation. Thus, a software program written to accomplish those same functions can emulate the functionality of the hardware components in the electronic circuitry.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

The term “message” generally refers to as information placed in a prescribed format that is transmitted in accordance with a suitable delivery protocol or accessible through a logical data structure such as an Application Programming Interface (API) or a web service or service such as a portal. Examples of a message may include one or more packets, frames, header/body data structure, or any other series of bits having the prescribed, structured format.

The term “coupled” is defined as meaning connected either directly to the component or indirectly to the component through another component.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. A cyber security appliance for data loss protection caused by an email message transmitted from or within an enterprise, comprising:
a communication module including one or more input/output (I/O) ports;
an email protection module communicatively coupled to the communication module, the email protection module comprises email threat detection logic to analyze content associated with the email message received via the one or more I/O ports for potential data loss characteristics;
an autonomous response module communicatively coupled to the email protection module, the autonomous response module is configured to cause a first set of autonomous actions directed to data loss prevention; and
where instructions implemented in software for the communication module, the email protection module, and the autonomous response module are configured to be stored in one or more non-transitory storage mediums to be executed by one or more processing units.

2. The cyber security appliance of claim 1, wherein the email threat detection logic of the email protection module further comprises high availability fail-open control logic configured to (i) detect operational failure of the email protection module or intake disruption via an Application Programming Interface (API) providing access to the email protection module and (ii) redirect email messages to cloud infrastructure pertaining to the enterprise for temporary storage and subsequent release of the redirected email messages upon detecting the operational failure or the intake disruption.

3. The cyber security appliance of claim 1, wherein the email threat detection logic of the email protection module is configured to analyze the content associated with the email message by at least analyzing (i) specific content uncovered from an analysis of the email message providing context surrounding the email message and (ii) results obtained from comparison of the email message to normal or expected enterprise-based communications.

4. The cyber security appliance of claim 3, wherein the analyzing of the specific content is conducted by a first analysis source corresponding to a first artificial intelligence based (AI-based) logic and the results obtained from the comparison of the email message to the normal or expected enterprise-based communications is conducted by a second analysis source corresponding to a second AI-based logic different than the first AI-based logic.

5. The cyber security appliance of claim 4, wherein the specific content uncovered from the analysis of the email message includes a message type of the email message identifying the email message as an outbound email message or a lateral email message or a size of the email message and the results obtain from the comparison are based on operations conducted by artificial intelligence (AI) based logic.

6. The cyber security appliance of claim 4, wherein features considered in analyzing the content associated with the email message differ based on a type of email message being either an outbound email message or a lateral email message and different sets of weightings used for analyzing the content associated with the email message differs based on the type of email message and a type of data loss characteristics detected being either an accidental data loss or a malicious data loss.

7. The cyber security appliance of claim 1, wherein the email protection module further comprises security mailbox assistant logic configured to generate, using artificial intelligence based (AI-based) logic, one or more feedback messages to an end user reporting the email message as an email security threat that identifies whether the email message constituted a data loss security threat and a brief explanation of notable factors as to why the email message warranted a data loss prevention action.

8. Implemented within a cyber security appliance, a non-transitory storage medium configured to store instructions in a format that, when executed by one or more processors, conducts data loss prevention evaluation of an email message to protect against exfiltration of sensitive data from an enterprise, the non-transitory storage medium comprising:
an email protection module including email threat detection logic to analyze content associated with the email message for potential data loss characteristics; and
high availability fail-open control logic configured to (i) detect operational failure of the email protection module or intake disruption of email messages via an Application Programming Interface (API) providing access to the email protection module and (ii) redirect the email messages to cloud infrastructure pertaining to the enterprise for temporary storage and subsequent release of the redirected email messages upon detecting the operational failure or the intake disruption.

9. The non-transitory storage medium of claim 8, wherein the email threat detection logic of the email protection module is configured to analyze the content associated with the email message by at least analyzing (i) specific content uncovered from an analysis of the email message providing context surrounding the email message and (ii) results obtained from comparison of the email message to normal or expected enterprise-based communications.

10. The non-transitory storage medium of claim 9, wherein the analyzing of the specific content is conducted by a first analysis source corresponding to a first artificial intelligence based (AI-based) logic and the analyzing of the results obtained from the comparison of the email message to the normal or expected enterprise-based communications is conducted by a second analysis source corresponding to a second AI-based logic different than the first AI-based logic.

11. The non-transitory storage medium of claim 10, wherein the specific content uncovered from the analysis of the email message includes a message type of the email message identifying the email message as an outbound email message or a lateral email message or a size of the email message and the results obtain from the comparison are based on operations conducted by artificial intelligence (AI) based logic.

12. The non-transitory storage medium of claim 10, wherein features considered in analyzing the content associated with the email message differ based on a type of email message being either an outbound email message or a lateral email message and different sets of weightings used for analyzing the content associated with the email message differs based on the type of email message and a type of data loss characteristics detected being either an accidental data loss or a malicious data loss.

13. The non-transitory storage medium of claim 8, wherein the email protection module further comprises security mailbox assistant logic configured to generate, using artificial intelligence based (AI-based) logic, one or more feedback messages to an end user reporting the email message as an email security threat that identifies whether the email message constituted a data loss security threat and a brief explanation of notable factors as to why the email message warranted a data loss prevention action.

14. A computerized method for conducting data loss prevention operations on email messages to protect against exfiltration of sensitive information from an enterprise, comprising:
analyzing content associated with an email message by an email protection module for potential data loss characteristics based on a comparison of content and context of the email message to normal or expected email message exchanges within the enterprise;
detecting an operational failure of the email protection module or intake disruption of email messages into the email protection module; and
redirecting the email messages to cloud infrastructure pertaining to the enterprise for temporary storage and subsequent release of the redirected email messages while the operational failure or intake disruption of the email protection module exists.

15. The computerized method of claim 14, wherein the analyzing of the content associated with the email message includes at least (i) analyzing specific content uncovered from an analysis of the email message providing context surrounding the email message and (ii) analyzing results obtained from the comparison of the content and context of the email message to normal or expected email message exchanges within the enterprise.

16. The computerized method of claim 15, wherein the analyzing of the specific content is conducted by a first analysis source corresponding to a large language module (LLM) and the analyzing of the results is conducted by an Artificial Intelligence (AI) model trained to detect normal and expected email message exchanges within the enterprise.

17. The computerized method of claim 16, wherein the specific content uncovered from the analysis of the email message includes determining whether the email message is an outbound email message or a lateral email message by at least determining differences in email domains between a sender of the email message and a targeted recipient of the email message.

18. The computerized method of claim 15, wherein the email protection module is configured to utilize a first set of weightings for features associated with the email message to analyze the email message operating as an outbound email message for potential data loss characteristics and utilize a second set of weightings, different from the first set of weightings, for at least some of the features associated with the email message to analyze the email message operating as a lateral email message for potential data loss characteristics.

19. The computerized method of claim 17, wherein the email protection module is configured to utilize different sets of weightings for analyzing the content associated with the email message differs based on a type of data loss characteristics detected being either an accidental data loss or a malicious data loss.

20. The computerized method of claim 14 further comprising:
generating, using artificial intelligence based (AI-based) logic, one or more feedback messages to an end user reporting the email message as an email security threat that identifies whether the email message constituted a data loss security threat and a brief explanation of notable factors as to why the email message warranted a data loss prevention action.
